(19) United States
(12) Patent Application Publication
(10) Pub. No.: US 2006/0157465 A1
(43) Pub. Date: Jul. 20, 2006

(54) Cushion element having seat heating

(76) Inventors: Sabine Karollus, Wurzburg (DE); Manfred Hofmann, Hettstadt (DE); Gerhard Schiffler, Markt Einersheim (DE)

Correspondence Address: MCGLEW & TUTTLE, PC, P.O. BOX 9227, SCARBOROUGH STATION, SCARBOROUGH, NY, 10510-9227, US

(21) Appl. No.: 11/330,738

(22) Filed: Jan. 12, 2006

(30) Foreign Application Priority Data
Jan. 19, 2005 (DE) 10 2005 002 693.1

(51) Int. Cl. H05B 3/00

(52) U.S. Cl. 219/217

(57) ABSTRACT

A cushion element (02, 03) in particular for producing a vehicle seat (01), is produced by foaming a polymer, in particular polyurethane, in a foam mold (12). At least one electrically heatable heating element (04, 05) is provided on the cushion element (02, 03) for heating the cushion element (02, 03). The heating element (04, 05) is foamed at least partially in the foam body (11) of the cushion element (02, 03).

### CROSS REFERENCE TO RELATED APPLICATIONS

This application claims the benefit of priority under 35 U.S.C. § 119 of German Patent Application DE 10 2005 002 693.1 filed Jan. 19, 2005, the entire contents of which are incorporated herein by reference.

### FIELD OF THE INVENTION

The present invention relates to a cushion element having seat heating, in particular for producing an automotive seat. The present invention also relates to a method for producing such cushion elements.

### BACKGROUND OF THE INVENTION

Generic cushion elements are used in the automotive industry in particular to produce heatable vehicle seats. The vehicle occupants then have the opportunity of electrically heating the seat surface and/or backrest surface of the vehicle seat by turning on the heating element to rapidly ensure a pleasant seat climate even at cold temperatures. Various fastening options have been proposed for securing the heating element on the cushion element of the vehicle seat.

German Patent Application DE 199 20 062 A1 describes a vehicle seat having electric seat heating. The heating wires of the seat heating are embedded in the upholstery padding in the disclosed embodiment.

German Utility Model DE 299 12 302 U1 describes a heating device for vehicle seats having a cushion support. A recess provided on the top side of the cushion support has a textile heating element secured in it by gluing.

One disadvantage of the known approaches for securing the heating element is that the seat comfort and/or climate comfort of the seat are often impaired due to the required fastening means. Furthermore there is the potential risk that the heating element might become detached from the cushion element and thereby result in damage and/or a disturbance in function.

### SUMMARY OF THE INVENTION

Against the background of this state of the art, the object of the present invention is therefore to provide a novel cushion element which avoids the disadvantages of the known state of the art. In addition, the object of the present invention is to provide a method for producing such cushion elements.

The inventive cushion element is based on the fundamental idea of foaming the heating element in situ in the foam of the cushion element. Foaming the heating element ensures that it is absolutely securely attached to the cushion element. Furthermore, this makes it possible to eliminate additional fastening elements for fastening the heating element, e.g., adhesive films or tacking stitches, which can have a negative effect on the seat comfort and/or the climate comfort of the seat.

Essentially it does not matter where on the cushion element the heating element is arranged. To achieve the most distortion-free heating effect, the heating element should run parallel to the seat surface and/or the surface of the backrest. An especially effective heating effect is achieved when the heating element is situated directly on the surface of the cushion element so that as a result the heating element is covered only by the upholstery material and, if necessary, a very thin layer of foam.

Essentially it does not matter which construction design is used for the heating element. According to a preferred embodiment, the heating element is formed by heating wires or stranded heating cables which may be designed to be flat to form a heating surface of the desired size.

Producing the inventive cushion element by foaming in situ a heating element requires the heating element to be secured in the correct position in the foam mold when foaming the polymer that is used. This may be accomplished, for example, by applying suitable fastening clamps or the like. The inventive cushion element can be manufactured especially inexpensively if the attachment of the heating element in the foam mold is implemented by generating a magnetic field. To do so, at least one positioning element must be provided on the heating element, this positioning element being magnetically securable by a suitable magnetic field in the foam mold.

Essentially it does not matter which type of magnetically securable positioning element is used. According to a first embodiment, the heating element is secured on a magnetically securable carrier element. The heating element secured in this way can then be positioned in the correct position by magnetically securing the carrier element in the foam mold and foaming in situ there. It is especially advantageous if the magnetically securable carrier element can be removed from the heating element after adequate curing of the foam body because it often has no other function after foaming.

For example, magnetically securable metal cloth, metal gratings or metal films may be used as the carrier element for securing the heating element. If heating wires or stranded heating cables are used as the heating element, they may be attached to the metal cloth, metal mesh or metal film, e.g., by applying an adhesive layer, and introduced into the foam mold together with this magnetizable carrier element so that foaming in situ can be performed with the heating wires or strands embedded in the correct position. It is then advantageous if the metal cloth, metal mesh or metal film is pulled away from the surface of the cushion element. However, it may also remain in the cushion element if suitable carrier elements are used.

As an alternative to using a magnetically securable carrier element for arranging the heating element in the correct position in the foam mold, it is also possible for the heating element itself to be made of a magnetically securable material. For example, if heating wires or stranded heating cables made of copper containing iron are used to produce the heating element, these stranded heating cables can be secured in the foam mold by generating a magnetic field.

When using heating wires or stranded heating cables to produce the heating element, it is especially important for the heating wires or stranded heating cables to run according to a predetermined installation plan in the cushion element. To ensure this relative arrangement of the individual sections of the heating wires or stranded heating cables, it is especially advantageous if the magnetically securable stranded heating cables are detachably secured on a carrier element, preferably an adhesive-coated plastic film. In this way, the carrier elements may be prefabricated with the stranded heating cables attached to them and later foamed into the foam body to produce the cushion elements. As soon as the heating wires or stranded heating cables are secured in the foam mold or foam body, the carrier element may then be removed because it is no longer needed to maintain the relative position between the individual sections of the stranded heating cables.

To produce cushion elements according to this invention, ultimately any foaming method may be used, in which case the heating elements for producing the seat heating are inserted into the foam mold before foaming the polymer to permit foaming in situ and/or foam coating of the heating element.

To magnetically secure the heating element in the foam mold, a magnetic element should be provided in or on the foam mold so that a suitable magnetic field can be generated.

By using permanent magnets to generate the magnetic field required to secure the heating element in the foam mold, a very high process reliability is ensured because permanent magnets are independent of an external power supply. In particular, permanent magnet films, preferably secured to the inside of the foam mold, may be used.

As an alternative to using permanent magnets, electromagnets may also be used to generate the magnetic field required to secure the heating elements in the foam mold. These electromagnets have the advantage in particular that the magnetic attachment of the heating element can be released by turning off the electromagnet. This is advantageous in particular in unmolding the cushion element from the foam mold because the attachment of the foam-coated heating element is released when the electromagnet is turned off and thus unmolding is facilitated.

When carrier elements to secure the heating element, in particular the stranded heating cables, are used there are two preferred process variants.

According to the first process variant, the carrier element serves only to position the heating element in the correct position in the foam mold before the foaming process. For example, if stranded heating cables made of a magnetizable material are used, these stranded cables can be correctly positioned in the foam mold by laying prefabricated carrier elements. Even before closing the foam mold and the subsequent foaming of the polymer, the carrier element is then pulled away from the stranded heating cables so that only the stranded heating cables are foamed in situ in the foam body.

According to the alternative process variant, the carrier element itself is secured by the magnetic field in the foam mold and is foam-backed together with the stranded heating cables in the foam mold. After fully filling up the foam mold with foam, the carrier element is then pulled away from the stranded heating cables that have been surrounded with foam in situ.

An embodiment of the present invention is diagrammed schematically in the drawings and explained in greater detail below as an example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view showing a vehicle seat according to the invention having electric seat heating;

FIG. 2 is a top view of a cushion element of the vehicle seat according to FIG. 1;

FIG. 3 is a sectional view taken along sectional line A-A showing the cushion element according to FIG. 2; and

FIG. 4 is a sectional view showing a foam mold for producing the cushion element according to FIG. 3.

### DESCRIPTION OF THE PREFERRED EMBODIMENTS

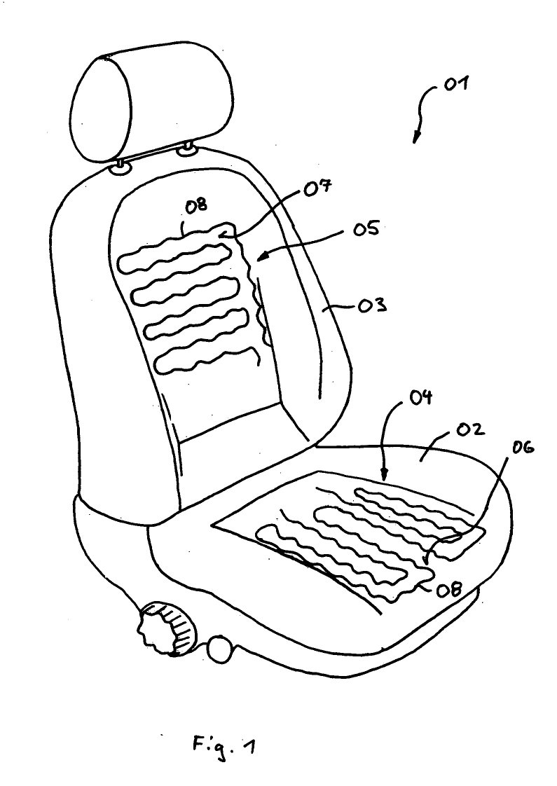

Referring to the drawings in particular, FIG. 1 shows a vehicle seat 01 having two cushion elements 02 and 03. The vehicle seat 01 contains a seat heater having two heating elements 04 and 05 with which the seat surface 06 and/or the backrest surface 07 can be heated electrically. In the final installation, the two cushion elements 02 and 03 are upholstered with an upholstery material (not shown in FIG. 1).

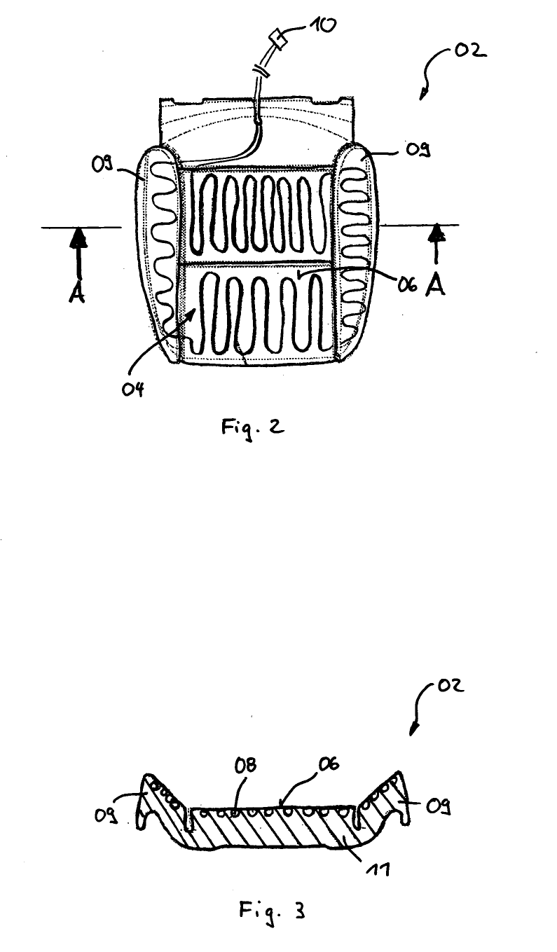

The two heating elements 04 and 05 are produced from stranded heating cables 08 which can be heated by applying an electric power supply voltage. The stranded heating cables 08 are foamed in situ in a flat position into the cushion elements 02 and 03 to form heating surfaces according to a predetermined installation plan and run directly at the surface of the cushion elements 02 and 03. The installation plan for the stranded heating cables 08 shown in FIG. 1 and FIG. 2 is to be understood as being merely schematic and does not necessarily correspond to the actual situation.

FIG. 2 shows the cushion element 02 in a view from above. It can be seen here that the stranded heating cables 08 extend not only along the seat surface 06 but are also arranged at the surface of the two lateral supporting cushions 09. A plug 10 is provided for connecting the heating element 04 to the vehicle electric system; the ends of the stranded heating cables 08 can be electrically contacted to this plug.

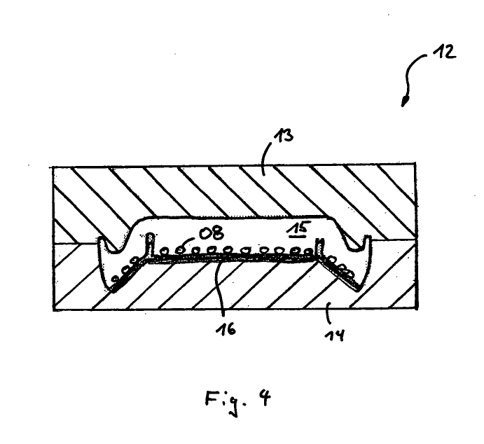

FIG. 3 shows a foam body 11 forming the cushion element 02, shown here in cross section. The stranded heating cables 08 are surrounded with foam in situ on the surface of the foam body 11 forming the seat surface 06.

FIG. 4 is a schematic representation of a two-part foam mold 12 to produce the foam body 11 with the stranded heating cables 08 surrounded with foam in situ. The procedure for producing the foam body 11 is described below.

First, the foam mold 12 is opened by raising the cover 13 so that the mold cavity is accessible from the outside. A permanent magnet film is secured in the foam mold 12 on the inside surface of the bottom part 14 of the foam mold 12 facing the mold cavity 15.

In a first step of the manufacturing process, the stranded heating cables 08 are inserted into the foam mold 12. To this end, the stranded heating cables 08 have been laid out in a prefabrication process on adhesive plastic films according to the installation plan and may thus be positioned in the correct position by simply inserting the plastic films into the foam mold 12 according to the predetermined installation plan. The stranded heating cables 08 produced from copper that contains iron then come in direct contact with the magnetic film 16 and are thus secured by the magnetic film 16 in the correct position in the foam mold 12.

In the second step of the manufacturing process, the plastic film is pulled away from the stranded heating cables and removed from the foam mold 12 after securing the stranded heating cables 08 on the magnetic film 16.

In the third step of the manufacturing process, the foam mold 12 is closed and the mold cavity 15 is foamed with a foamable polymer, e.g., a polyurethane, with the formation of the foam body 11. The stranded heating cables are surrounded with foam in situ in the foam body 11 by foaming the polymer and therefore they are secured in the correct positions on the cushion element 02.

Last of all, the foam mold 12 is opened and the cured foam body 11 with the stranded heating cables 08 foamed in situ is unmolded.

While specific embodiments of the invention have been shown and described in detail to illustrate the application of the principles of the invention, it will be understood that the invention may be embodied otherwise without departing from such principles.

What is claimed is:

1. A cushion element for producing a vehicle seat, the cushion element comprising:
a cushion element foam body produced by foaming a polymer in a foam mold;
at least one electrically heatable heating element provided on the cushion element foam body, the heating element for heating the cushion element foam body, the heating element being surrounded by foam at least partially in the foam body.

2. The cushion element according to claim 1, wherein the heating element extends parallel to the seat surface and/or the backrest surface of the vehicle seat, adjacent to the surface of the cushion element and the foam is polyurethane.

3. The cushion element according to claim 1, wherein the heating element is formed by strand heating cables or heating wires laid out in a flat pattern.

4. The cushion element according to claim 1, further comprising: a positioning element which is provided on the heating element, said heating element being securable magnetically by said positioning element generating a magnetic field in the foam mold.

5. The cushion element according to claim 4, wherein the heating element comprises heating wires or stranded heating cables secured on said positioning element, said positioning element defining a magnetically securable carrier element.

6. The cushion element according to claim 5, wherein the heating element is detachable from the magnetically securable carrier element.

7. The cushion element according to claim 6, wherein a magnetically securable metal cloth or metal mesh or metal film is provided as the carrier element.

8. The cushion element according to claim 4, wherein the heating element comprises stranded heating cables or heating wires made at least in part of a magnetically securable material comprising copper that contains iron.

9. The cushion element according to claim 8, wherein the magnetically securable stranded heating cables or heating wires are attached to a carrier element.

10. The cushion element according to claim 9, wherein a plastic film is provided comprising a film coated with adhesive on one side and forming said carrier element.

11. A method for producing a cushion element, having a cushion element foam body and a heating element for heating the cushion element, the method comprising:
inserting the heating element into a foam mold; and
foaming a polymer to surround the heating element by foam at least partially.

12. The method according to claim 11, wherein the heating element is magnetically secured in the foam mold by a magnetic field of a magnetic element provided in or on the foam mold.

13. The method according to claim 12, wherein the magnetic field is generated by a permanent magnet forming a permanent magnet film.

14. The method according to claim 12, wherein the magnetic field is generated by an electromagnet.

15. The method according to claim 14, wherein the magnetic field generated by the electromagnet is turned off after the heating element has been surrounded by foam in situ.

16. The method according to claim 11, further comprising:
providing a carrier element;
securing heating cables or heating wires of said heating element on said carrier element wherein said carrier element is provided on the side of the heating element facing the interior of the mold cavity of the foam mold; and
removing the carrier element from the heating wires or heating cables and from the foam mold before filling up the foam mold with foam.

17. The method according to claim 11, further comprising:
providing a carrier element;
securing heating cables or heating wires of said heating element on said carrier element wherein said carrier element is provided on the side of the heating element facing a mold wall of the foam mold; and
removing the carrier element from the secured heating cables covered with foam after the foam mold has been filled with foam.
